(19) United States
(12) Patent Application Publication
(10) Pub. No.: US 2010/0201216 A1
(43) Pub. Date: Aug. 12, 2010

(54) BEARING DEVICE FOR NON-CONTACTING BEARING OF A ROTOR WITH RESPECT TO A STATOR

(75) Inventors: Peter Kummeth, Herzogenaurach (DE); Martino Leghissa, Wiesenthau (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: SIEMENS AKTIENGESELLSCHAFT, München (DE)

(21) Appl. No.: 12/665,592

(22) PCT Filed: Jun. 18, 2008
(86) PCT No.: PCT/EP2008/057647

§ 371 Date: Dec. 18, 2009

(30) Foreign Application Priority Data
Jun. 22, 2007 (DE) 10 2007 028 905.9

(51) Int. Cl. H02K 7/09; F16C 32/06

(52) U.S. Cl. 310/90.5; 384/114

(57) ABSTRACT

The invention relates to a bearing device (100) for the contactless bearing of a rotor in relation to a stator (101). Said bearing device (100) comprises a rotor provided with a shaft (102) and at least one rotor disk (103), and a stator (101) provided with at least two stator disks (105, 106). Said stator (101) at least partially surrounds the rotor at a certain distance and the rotor disks (103) protrude into the intermediate chamber (104) between the rotor disks thus forming a bearing gap (107). Said bearing device (100) also comprises a magnetic bearing part for bearing the rotor in a radial manner and an air bearing part for bearing the rotor in an axial manner.

The invention relates to a bearing device for non-contacting bearing of a rotor with respect to a stator. The rotor has at least one shaft which can rotate about an axis, wherein at least one rotor disk is mechanically connected to the shaft. The stator has at least two stator disks which are separated in the axial direction forming an intermediate space. The at least one rotor disk projects into the intermediate space, forming a bearing gap. By way of example, one such bearing device is disclosed in DE 10 2005 028 209 A1.

Bearing devices for non-contacting bearing of a rotor with respect to a stator allow the rotor to be borne without any contact and without wear, require no lubricants and can be designed to have low friction or virtually no friction. Bearing devices such as these may, for example, be magnetic bearings. Magnetic bearing devices can be designed using permanent-magnet elements, windings for producing a magnetic field, or else in the form of superconducting magnetic bearings.

Magnetic bearings may be actively regulated or may be designed to be partially intrinsically stable.

Active regulated magnetic bearings have a regulating apparatus by means of which the magnetic bearing forces are appropriately regulated for active stabilization of the rotor. Active regulation typically includes complex control electronics, and is therefore costly. In order to prevent the rotor from crashing if the control electronics fail, active regulated magnetic bearings have additional mechanical back-up bearings. An additional mechanical back-up bearing represents increased design complexity for the magnetic bearing and therefore causes additional costs.

Partially intrinsically stable magnetic bearings may be intrinsically stable in the radial direction or axial direction with respect to the rotation axis of the rotor. By way of example, if a bearing such as this is intrinsically stable in the radial direction, then, for example, it has a ferrofluid bearing or a needle bearing for axial stabilization of the rotor. In contrast to the magnetic bearing part which is designed not to make contact, the mechanical bearing part causes friction losses. Partially intrinsically stable bearing devices such as these are disclosed, for example, in M. Siebert et al.: A Passive Magnetic Bearing Flywheel. NASA/™-2002-211159, 2001. A further magnetic bearing which is intrinsically stable in the radial direction and additionally has a high bearing force is disclosed, for example, in DE 10 2005 028 209 A1.

A radially intrinsically stable magnetic bearing which has active regulation for axial stabilization is disclosed, for example, in DE 10 2005 030 139 A1.

Both an actively regulated magnetic bearing and a mechanically stabilized, partially intrinsically stable magnetic bearing, only partially achieve the actual advantages of a magnetic bearing.

The object of the present invention is to specify an intrinsically stable bearing device for non-contacting bearing of a rotor with respect to a stator, which is improved with respect to the technical problems that occur in the prior art. One particular aim is for the bearing device to dispense with mechanical bearing components and active electronic regulation of a magnetic bearing part.

According to the invention, the abovementioned object is achieved by the measures specified in claim 1 or claim 4.

The invention is in this case based on the idea of additionally providing a bearing device which has a magnetic bearing part which is intrinsically stable in the radial direction with an air bearing which stabilizes the rotor, which is mounted magnetically with respect to the stator, in an axial direction. The axial stabilization of the rotor by means of an air bearing can be provided both on one side and in both axial directions. In order to stabilize the rotor on one side, the magnetic bearing part of the bearing device according to the invention is designed such that the rotor is subject to a permanent magnetic force in an axial preferred direction. This means that the rotor need be supported only with respect to this preferred direction by means of an air bearing device.

According to the invention, the bearing device for non-contacting bearing of a rotor with respect to a stator, as claimed in claim 1, should have the following features.

The bearing device for non-contacting bearing of a rotor with respect to a stator comprises a rotor, a stator, a magnetic bearing part and an air bearing part. The rotor has at least one shaft which can rotate about an axis, and to which at least one rotor disk is mechanically connected. The stator has at least two stator disks, which are separated in the axial direction, forming an intermediate space, with the at least one rotor disk projecting into the intermediate space, forming a bearing gap. The magnetic bearing part is used for bearing the rotor in a radial direction with respect to the axis, and the air bearing part is used for bearing the rotor in an axial direction with respect to the axis. As part of the magnetic bearing part, the at least one rotor disk and the stator disks have annular tooth-like projections, which are opposite across an air gap, on their mutually facing sides. Furthermore, the rotor or the stator contains means for producing a magnetic field, in order to produce a magnetic holding flux which is directed essentially in an axial direction between the at least one rotor disk and the stator disks. As part of the air bearing part, the stator has at least one bearing surface whose surface normal is oriented essentially in an axial direction. Furthermore, the rotor has at least one bearing body, which is at a distance from the bearing surface, forming an air bearing gap. The bearing body is borne with respect to the bearing surface by an air cushion which is provided in the air bearing gap.

Alternatively, the bearing device according to the invention and as claimed in claim 4 may have the following features:

The bearing device for non-contacting bearing of a stator with respect to a rotor comprises a rotor, a stator, a magnetic bearing part and an air bearing part. The rotor has at least one shaft which can rotate about an axis, wherein at least two rotor disks, which are at a distance in the direction of the axis forming an intermediate space, are mechanically connected to the shaft. The stator has at least one stator disk which projects into the intermediate space, forming a bearing gap. The magnetic bearing part is used for bearing the rotor in a radial direction with respect to the axis, and the air bearing part is used for bearing the rotor in an axial direction with respect to the axis. As part of the magnetic bearing part, the at least two rotor disks and the at least one stator disk are provided on their immediately facing sides with annular tooth-like projections which are each opposite across a bearing gap. Furthermore, the rotor or the stator contains means for producing a magnetic field, in order to produce a magnetic holding flux, which is directed essentially in an axial direction between the at least one stator disk and the at least two rotor disks. As part of the air bearing part, the stator has at least one bearing surface, whose surface normal is oriented essentially in an axial direction. The rotor has at least one bearing body, which is at a distance from the bearing surface forming an air bearing gap and is borne with respect to the bearing surface by means of an air cushion which is provided in the air bearing gap.

The advantages that are associated with the measures according to the invention are in particular that the bearing device allows completely non-contacting bearing of a rotor with respect to a stator. The bearing device is simple to design and allows completely intrinsically stable bearing of the rotor with respect to the stator.

Advantageous refinements of the bearing device according to the invention are specified in the claims which are dependent on claims 1 and 4. In this case, the embodiments according to claim 1 and claim 4 may be combined with the features of one dependent claim, and in particular with those of a number of dependent claims.

Accordingly, the bearing device may also have the following features:
The bearing device may have n>2 stator disks, which are separated in the direction of the axis with intermediate spaces being formed, and n−1 rotor disks, which project into these intermediate spaces forming bearing gaps. Alternatively and equivalently, the bearing device may have n>2 rotor disks, which are separated in the direction of the axis with intermediate spaces being formed, and n−1 stator disks, which project into the intermediate spaces forming bearing gaps. If the bearing device has a multiplicity of stator and rotor disks, the bearing force of the bearing device can be increased.
The bearing device may have two or more stator disk pairs which are separated from one another in the direction of the axis, each formed from two stator disks. Between the stator disks which form a stator disk pair there is an intermediate space in each case, into which in each case one rotor disk projects, forming a bearing gap. Alternatively, two or more rotor disk pairs, which are at a distance from one another in the direction of the axis, may be formed by in each case two rotor disks. The rotor disks which form the rotor disk pairs in each case have an intermediate space between them in each case one, into which stator disk projects, forming a bearing gap. Construction of the bearing device with stator disk pairs and/or rotor disk pairs makes it possible to specify a bearing device design which is modular and therefore flexible from the production engineering point of view.
The axial extent of the bearing gap may be less in a preferred direction than in an opposite direction thereto. The air bearing part of the bearing device may be connected at the end to an end part of the shaft, which lies in the direction of the preferred direction starting from the magnetic bearing part. An asymmetric configuration of the bearing gap of the magnetic bearing part of the bearing device results in the magnetically borne rotor being subject to a permanent magnetic force in the preferred direction. Correspondingly, the rotor may be supported only counter to this preferred direction by means of an air bearing part. One-side bearing of the rotor such as this by means of an air bearing represents a cost-effective solution, of simple design.

The bearing surface of the air bearing part may be formed by the subareas of the tooth-like projections of at least one stator disk, wherein only those subareas of the tooth-like projections form the bearing surface of the air bearing part whose surface normals point in an axial direction. Furthermore, only those parts of the tooth-like projections are used as a bearing surface for the air bearing part which lie in the direction of the preferred direction, starting from the associated rotor disk. According to the abovementioned exemplary embodiment, the bearing surface which is used for air bearing is provided in the area of the tooth-like projections of the stator disks. This makes it possible to specify a space-saving and compact bearing device.
The air bearing part may be connected at the end to both end parts of the shaft. The use of air bearings on both sides of the rotor makes it possible to specify a completely intrinsically stable bearing.
The bearing surface of the air bearing part may be formed by those subareas of the tooth-like projections of at least two stator disks whose surface normals point in opposite axial directions. According to the abovementioned embodiment, a bearing which is intrinsically stable in both axial directions can be specified, which can also be made particularly compact by integration of the air bearing surfaces in the area of the tooth-like projections of the bearing disks.
The stator may have means for producing a magnetic field, in the form of permanent magnets or the winding of an electromagnet, and the rotor may have means for producing a magnetic field, in the form of permanent magnets. Flexible design of the means for producing a magnetic field, optionally as part of the stator or of the rotor, allows flexible matching of the magnetic flux routing to further design constraints for the bearing device.
The air bearing part may be in the form of a foil air bearing. A foil air bearing advantageously allows non-contacting bearing of moving components without any external compressed-air supply being required.
The stator may be connected to a compressed-air supply in order to produce the air cushion, wherein the compressed-air supply has a buffer volume in order to maintain the air cushion for a limited time. When a buffer volume is used as part of the compressed-air supply, the bearing device according to the above embodiment can be protected against failure of the compressed-air supply. This makes it possible to improve the reliability of the bearing device.

Further advantageous refinements of the bearing device according to the invention are specified in the dependent claims which, have not been referred to above, and in particular from the drawing. In order to explain the invention further, the following text refers to the drawing, in which preferred embodiments of the bearing device according to the invention are illustrated schematically, and in which:

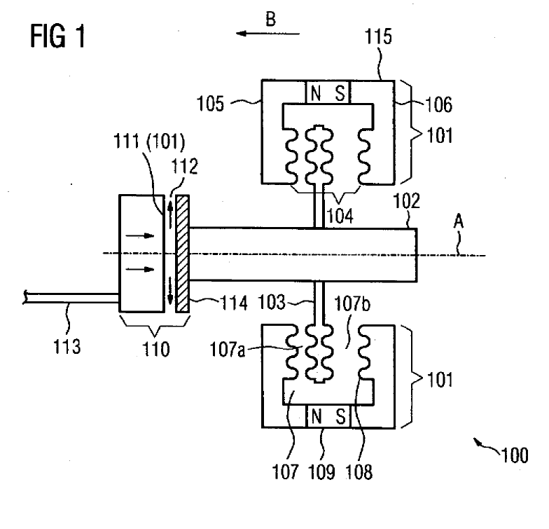

FIGS. 1 to 6 show bearing devices whose rotor is supported on one side by means of an air bearing,

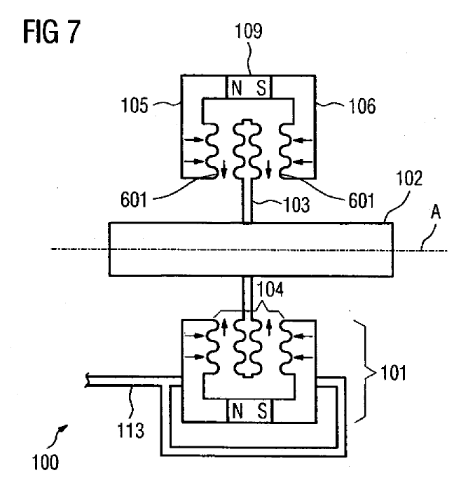

FIGS. 7 to 9 show bearing devices whose rotor is supported in both axial directions by means of an air bearing device, and

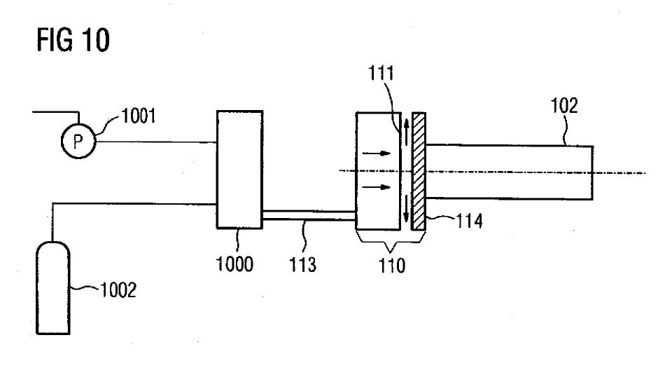

FIG. 10 shows the compressed-air supply for an air bearing device.

Corresponding parts in the figures are provided with the same reference symbols. Parts which are not described in any more detail are generally known prior art.

FIG. 1 shows a bearing device 100 for non-contacting bearing of a rotor with respect to a stator 101. The rotor has at least one shaft 102, which is mounted such that it can rotate about an axis A and to which a rotor disk 103 is mechanically connected. The stator 101 has two stator disks 105, 106, which are separated in the direction of the axis A, forming an intermediate space 104. The stator disks 105, 106 are connected on their radially outer areas to a yoke body 115. The stator 101 at least partially surrounds the rotor. In particular, the stator 101 together with the stator disks 105, 106 may form a component with a U-shaped profile when seen in cross section, which completely surrounds the rotor disk 103 in the circumferential direction. The rotor disk 103 projects into the intermediate space 104 between the stator disks 105, 106 forming a bearing gap 107. The rotor disk 103 and the stator disks 105, 106 have mutually opposite tooth-like projections 108 on their mutually facing sides. The tooth-like projections 108 may each be in the form of projections which are annular with respect to the axis A. As the means for producing a magnetic field, the stator 101 has a permanent magnet 109 which, in particular, may be in the form of an annular part of the stator 101, surrounding the rotor in the circumferential direction. The permanent magnet 109 can be used to produce a magnetic flux which is directed essentially in an axial direction in the area of the bearing gap 107 between the tooth-like projections on the stator disks 105, 106 and the rotor disk 103. The magnetic flux path is closed via the yoke body 115, which is part of the stator 101.

The bearing device 100 also has an air bearing 110, which is connected to an end part of the shaft 102. The air bearing 110 has a bearing surface 111 which is mechanically connected to the stator 101. The bearing surface 111 is oriented such that its surface normal is oriented essentially parallel to the axis A. In particular, the bearing surface 111 may be provided with inlet nozzles, may have inlet chambers, and/or may be provided with various channels, microchannels or else micronozzles. The bearing surface 111 may also be a porous, sintered surface, through which the compressed air which is required for the air bearing 110, can flow into the air bearing gap 112. The bearing surface 111 is part of the static part of the air bearing 110 and is connected to a compressed-air supply in order to supply compressed air via a supply line 113. The air bearing 110 also has a bearing body 114 which is part of the rotor, or is mechanically connected to it. An air cushion is produced by means of compressed air in the air bearing gap 112 in order to provide a bearing for the bearing body 114 with respect to the bearing surface 111.

Alternatively, the air bearing part may be in the form of a foil air bearing. A foil air bearing such as this allows non-contacting bearing of a moving shaft 102 by means of a self-forming air cushion. In the case of a foil air bearing, an air cushion is built up hydrodynamically in the air bearing gap 112 by the rotation of the shaft 102. A foil air bearing typically has no additional mechanical back-up bearing. When the shaft 102 is being started up or accelerated, the foil air bearing first of all operates in the form of a journal bearing, until an appropriately load-bearing air cushion has been built up hydrodynamically in the air bearing gap 112.

The bearing device 100 shown in FIG. 1 is designed such that the bearing gap 107 has a shorter extent in an axially preferred direction B, seen from the rotor disk 103, than in the opposite direction to the preferred direction B. In consequence, the part 107a of the bearing gap 107 which is located between the rotor disk 103 and the rotor disk 105 facing the air bearing 110 is shorter in the axial direction than that part 107b of the bearing gap 107 which is located between the rotor disk 103 and the stator disk 106 facing away from the air bearing 110. Because of the different axial sizes of the bearing gaps 107a, 107b, the shaft 102 is permanently subject to a magnetic force effect in the direction of the preferred direction B. This magnetic force, which acts permanently on the rotor, is supported by the air bearing 110 which is provided on the end area of the shaft 102.

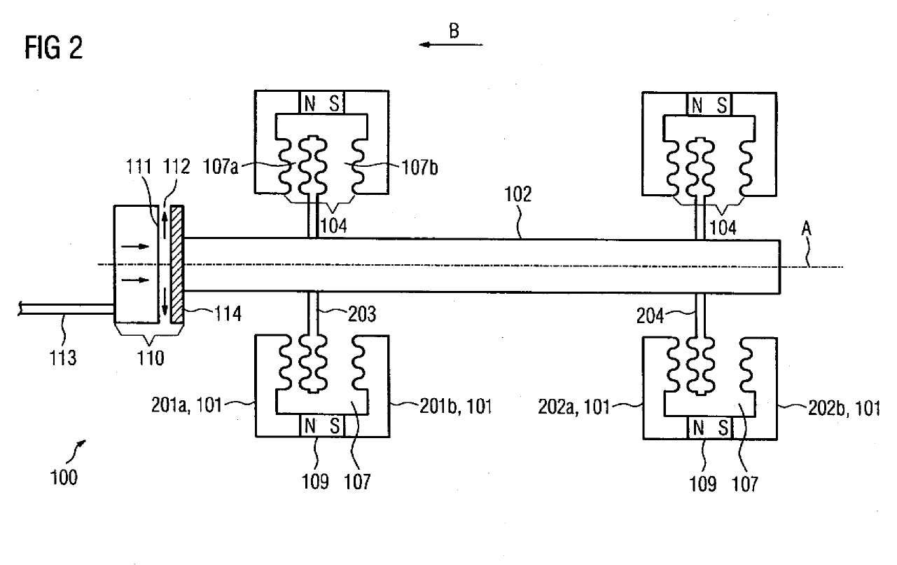

FIG. 2 shows a further bearing device 100, whose stator 101 has two stator disk pairs 201a, 201b, 202a, 202b. The bearing device 100 also has two rotor disks 203, 204, which each project into the intermediate space 104 between the stator disk pairs 201a, 201b and 202a, 202b, forming a bearing gap 107.

The stator disk pairs 201a, 201b, 202a, 202b, which are parts of the stator 101, each have means for producing a magnetic field, in the form of permanent magnets 109.

The further bearing device 100 shown in FIG. 2 has bearing gaps 107a, 107b, in the same way as the bearing device 100 shown in FIG. 1, which are of different size in an axial direction. In consequence, the shaft 102 is subject to the influence of the force in the direction of the preferred direction B, and this force is supported by the air bearing 110 fitted to the end of the shaft 102.

Although this is not shown in FIG. 2, the bearing device 100 will likewise have further stator disk pairs 201a, 201b, 202a, 202b, as a result of which the bearing device 100 has a greater bearing force.

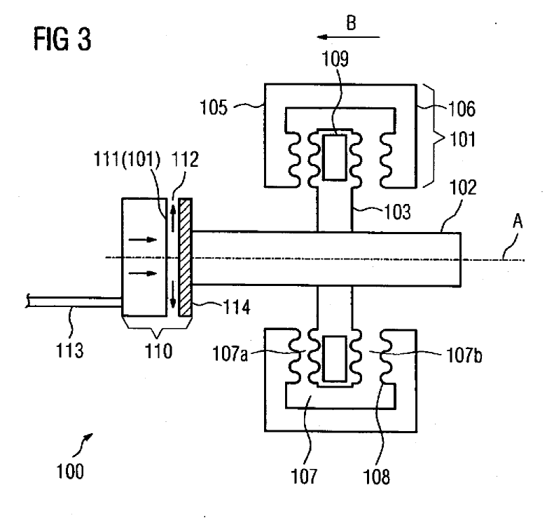

FIG. 3 shows a further bearing device 100, which can be designed analogously to the bearing device 100 illustrated in FIG. 1. Only the means for producing a magnetic field, in the form of a permanent magnet 109, are formed as part of the rotor disk 103.

The means for producing a magnetic field, when they are part of the stator 101, may be formed by permanent magnets and/or by the winding of an electromagnet. If the means for producing a magnetic field are part of the rotor, then they can likewise be formed by permanent magnets and/or by the winding of an electromagnet.

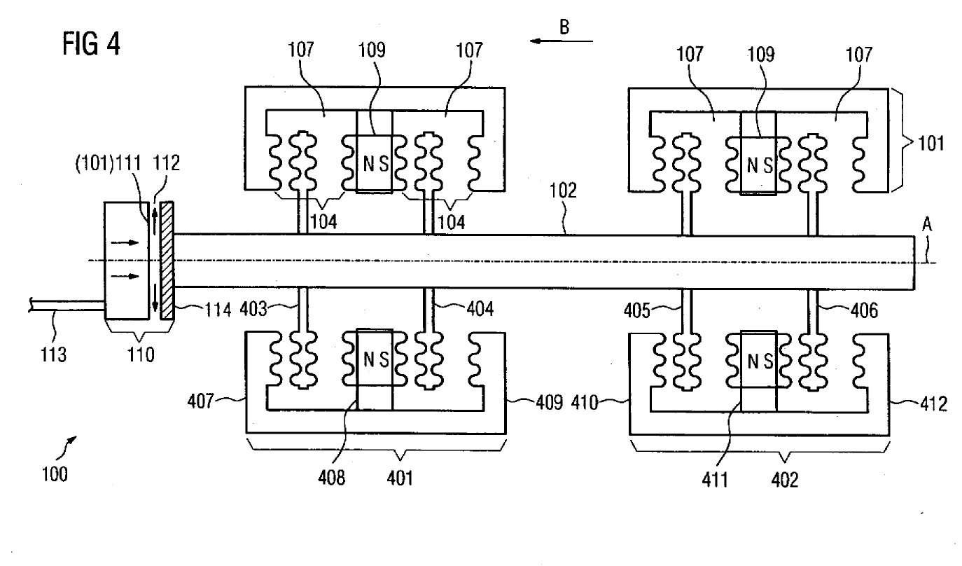

FIG. 4 shows a further bearing device 100, which has two magnetic bearing elements 401, 402. Each of the magnetic bearing elements 401, 402 each has two rotor disks 403, 404 and 405, 406, which are connected to the shaft 102 and project in an intermediate space 104 between the respective stator disks 407 to 412. As the means for producing a magnetic field, each of the bearing elements 401, 402 in each case has one permanent magnet 109. An air bearing 110 is located at the end of the shaft 102 and is used to support the shaft 102 in the preferred direction B. Analogously to the statements relating to FIGS. 1 to 3, the bearing gaps 107 which are formed between the stator disks 407 to 412 and the rotor disks 403 to 406 are smaller in the direction of the preferred direction B, when seen from the rotor disks 403 to 406 in the direction of the stator disks 407 to 412, than in the opposite direction to the preferred direction B. The force exerted on the shaft 102 in the preferred direction B is supported by the air bearing 110 which exists at one end of the shaft 102.

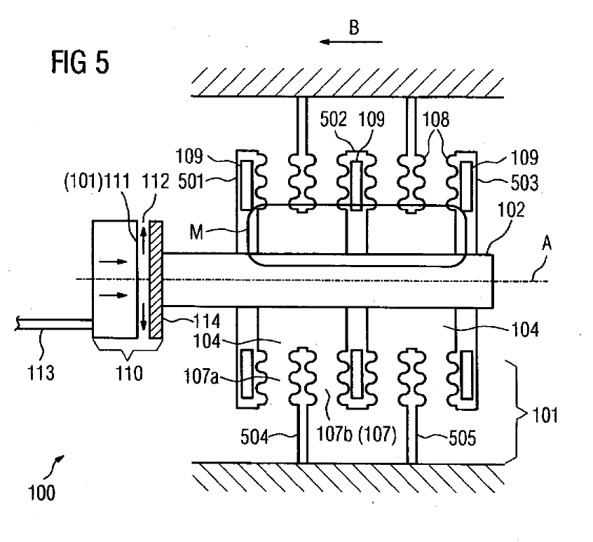

FIG. 5 shows a further bearing device 100 with a rotor which is mounted so that it can rotate about an axis A. The rotor comprises a shaft 102 to which rotor disks 501 to 503 are mechanically connected. The stator 101 comprises two stator disks 504, 505, which project into the intermediate space 104 which exists between each of the rotor disks 501 to 503. The stator 101 at least partially surrounds the rotor in the circumferential direction. In the axial direction, the stator disks 504, 505 are enclosed by the rotor disks 101 to 103. The bearing gaps 107 which are formed between the rotor disks 501 to 503 and the stator disks 504, 505 are designed such that the bearing gap is of a smaller size, starting from a stator disk 504, 505 in a preferred direction B, than in the opposite direction to the preferred direction B. The bearing gap 107a between the rotor disk 501 and the stator disk 504 is therefore smaller than the bearing gap 107b between the stator disk 504 and the rotor disk 502. The force effect which results from the different size of the bearing gaps 107a, 107b in the direction of the preferred direction B is supported by an air bearing 110 which is connected to the shaft 102 at the end.

As the means for producing a magnetic field, the bearing device 100 shown in FIG. 5 has permanent magnets 109 which are each a part of the rotor disks 501 to 503. The permanent magnets 109 produce a magnetic holding flux M, which is directed essentially in an axial direction between the tooth-like projections 108 on the rotor disks 501 to 503 and on the stator disks 504, 505. According to the exemplary embodiment illustrated in FIG. 5, the magnetic holding flux path M is closed via parts of the shaft 102.

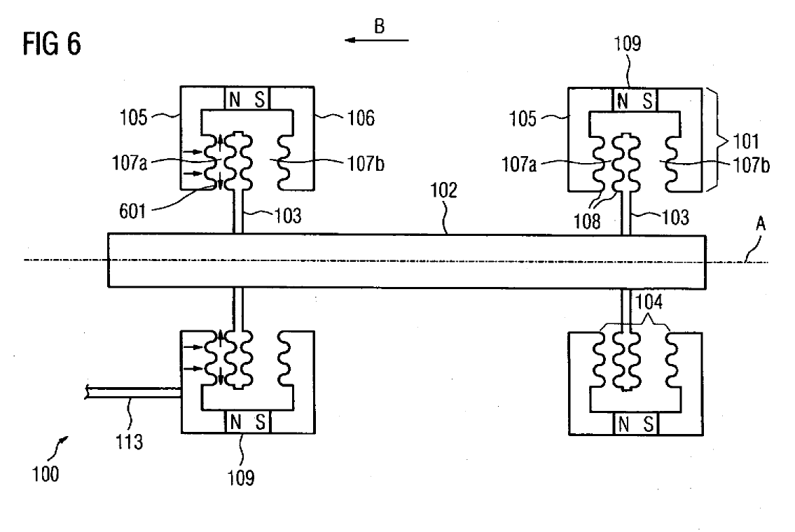

FIG. 6 shows a further bearing device 100, whose magnetic part is comparable to that of the bearing device shown in FIG. 2. The rotor disks 103 which are connected to the shaft 102 each project into intermediate spaces 104 which are formed between the stator disks 105, 106. The bearing gaps 107a, 107b which are formed between the rotor disks 103 and the stator disks 105, 106 are on different sizes in the axial direction. Because of the different size of the bearing gaps 107a, 107b, the shaft 102 is subject to a force acting in the direction of the preferred direction B. The air bearing part of the bearing device 100 shown in FIG. 6 is integrated in the tooth-like projections 601 on a rotor disk. The tooth-like projections 108 on the stator disk 105 have nozzles or outlets, as a result of which an air cushion acting as an air bearing can be built up in the bearing gap 107a. The specially shaped tooth-like projections 601 on the stator disk 105 are in this case designed in the same manner as the bearing surfaces 111 on their surfaces whose surface normals run essentially parallel to the axis A. The special tooth-like projections 601 can therefore be provided with nozzles, channels, recesses, micronozzles or further measures in order to produce an air cushion for the air bearing in the bearing gap 107a. The special tooth-like projections 601 may also be manufactured from a porous, air-permeable sintered material.

The bearing device 100 shown in FIG. 6 has a bearing disk 105 which is designed such that its tooth-like projections 601 are used to produce an air cushion in the bearing gap 107a. The bearing device may also be designed such that further bearing disks 105 have correspondingly designed tooth-like projections 601.

FIG. 7 shows a further bearing device 100. A rotor, disk 103 which is connected to the shaft 102 projects into the intermediate space 104 between the stator disks 105, 106, forming a bearing gap 107. The stator disks 105, 106 are provided with air outlets, comparable to an air bearing, on their tooth-like projections 601. This allows the bearing gap 107 between the rotor disk 103 and the two stator disks 105, 106 to be kept the same size. The shaft 102 or the rotor disk 103 which is connected to the shaft 102 can be kept stable by this air bearing on both sides in the axial direction. Both stator disks 105, 106 are connected to a compressed-air supply through a supply line 113, in order to create the air bearing.

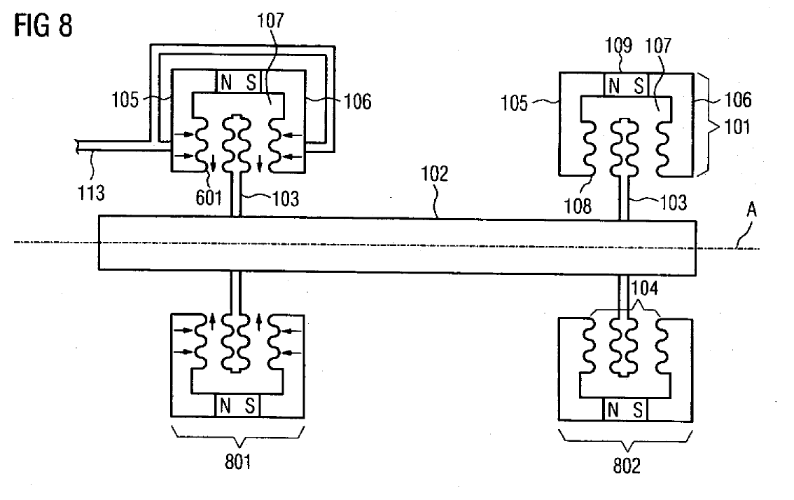

FIG. 8 essentially shows the bearing device 100 that is known from FIG. 7. The further bearing device 100 shown in FIG. 8 has two bearing elements 801, 802. One or both bearing elements 801, 802 can optionally contribute both to the magnetic bearing of the shaft 102 and to the magnetic and air bearing of the shaft 102.

One or both bearing elements 801, 802 can optionally correspondingly have tooth-like projections 601 which are designed to produce an air cushion in the bearing gap 107, by means of nozzles or further suitable measures.

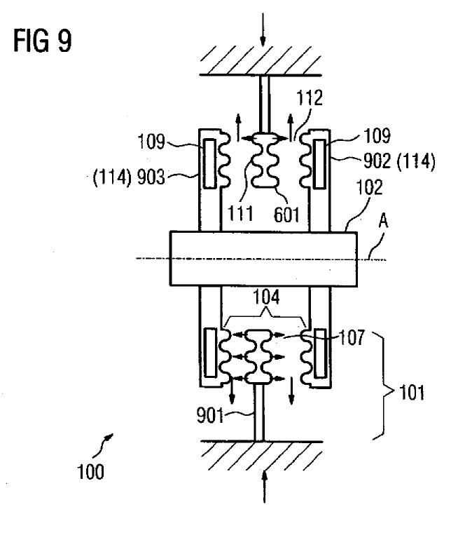

FIG. 9 shows a bearing device 100 in which two rotor disks 105, 106 are connected to a shaft 102 that is mounted such that it can rotate about an axis A, and each have a permanent magnet 109 as the means for producing a magnetic field. The rotor is at least partially surrounded by a stator 101 in the circumferential direction. In the axial direction, the stator disk 901 is enclosed by the rotor disks 902, 903. The stator disk 901 is provided with air outlets on its tooth-like projections 601, such that the rotor disks 902, 903 can be held in both axial directions by means of an air cushion which is created between the tooth-like projections.

FIG. 10 shows a part of an air bearing 110 which is connected at the end to a shaft 102. The air bearing 110 is connected to a compressed-air supply 1000 via a supply line 113. The compressed-air supply 1000 is fed by means of a pump 1001. The compressed-air supply 1000 is also connected to a buffer volume 1002. If the pump 1001 fails, the compressed-air supply 1000 can thus be fed by means of the buffer volume 1002. The buffer volume 1002 may also be of such a size that the compressed-air supply 1000 can be fed by means of the buffer volume 1002 until, for example, the pump 1001 can be repaired, replaced or made operable again in some other way, within a supply time which can be achieved in this way.

1.-16. (canceled)

17. An arrangement, comprising:
a stator having at least two stator disks arranged in axial spaced-apart relationship to thereby define an intermediate space;
a rotor having a shaft which is rotatable about a rotor axis, and at least one rotor disk which is mechanically connected to the shaft and arranged to project into the intermediate space to thereby define a bearing gap between confronting faces of the rotor disk and the stator disks on either side of the rotor disk; and
a bearing device for non-contacting support of the rotor with respect to the stator, said bearing device comprising
a magnetic bearing part for supporting the rotor in a radial direction with respect to the rotor axis, said magnetic bearing part including
annular tooth-like projections formed on the confronting faces of the rotor disk and the stator disks in an area of the bearing gaps, and
means, provided on one of the rotor and stator, for generating a magnetic field to produce a magnetic holding flux which is directed essentially in an axial direction between the rotor disk and the stator disks, and
an air bearing part for supporting the rotor in an axial direction with respect to the rotor axis, said air bearing part including
at least one bearing surface formed on the stator and defining a surface normal which is oriented essentially in an axial direction, and
at least one bearing body provided on the rotor in spaced-apart relationship to the bearing surface of the stator to thereby define an air bearing gap, said bearing body being supported with respect to the bearing surface by an air cushion in the air bearing gap.

18. The arrangement of claim 17, comprising n>2 of stator disks arranged in spaced-apart relationship in a direction of the rotor axis with intermediate spaced being defined, and n−1 rotor disks, which project into the intermediate spaces to thereby form corresponding bearing gaps between confronting faces of the rotor disks and the stator disks on either side of each rotor disk.

19. The arrangement of claim 17, comprising two or more stator disk pairs arranged in spaced-apart relationship in a direction of the rotor axis, each stator disk pair including two stator disks, wherein the stator disks of the stator disk pairs define pairs of intermediate spaces into which two or more rotor disks project to define respective bearing gaps.

20. The arrangement of claim 17, wherein the bearing gap has in a preferred direction an axial extent which is less than an axial extent in a direction opposite to the preferred direction, and wherein the air bearing part is connected at an end face thereof to an end part of the shaft, which end part lies in the preferred direction starting from the magnetic bearing part.

21. New) The arrangement of claim 17, wherein the bearing gap has in a preferred direction an axial extent which is less than an axial extent in a direction opposite to the preferred direction, and wherein the bearing surface of the air bearing part is formed by subareas of the tooth-like projections of at least one stator disk whose surface normal points in the direction of the rotor axis, said subareas of the stator disk which lie in the direction of the preferred direction, starting from the rotor disk associated with the stator disk, defining the bearing surface.

22. The arrangement of claim 17, wherein the air bearing part is connected at an end face thereof to both end parts of the shaft.

23. The arrangement of claim 17, wherein the bearing surface of the air bearing part is formed by subareas of the tooth-like projections of the at least two stator disks whose surface normals point in opposite axial directions.

24. The arrangement of claim 17, wherein the means of producing a magnetic field are part of the stator.

25. The arrangement of claim 24, wherein the means of producing a magnetic field are formed by permanent magnets or by a winding of an electromagnet.

26. The arrangement of claim 17, wherein the means for producing a magnetic field are part of the rotor.

27. The arrangement of claim 26, wherein the means for producing a magnetic field are formed by permanent magnets.

28. The arrangement of claim 17, further comprising a compressed-air supply connected to the stator for generating the air cushion in the air bearing gap, and a buffer volume connected to the compressed-air supply to maintain the air cushion for a limited time.

29. The arrangement of claim 17, wherein the air bearing part is constructed in the form of a foil air bearing.

30. An arrangement, comprising:
a rotor having a shaft which is rotatable about a rotor axis, and at least two rotor disks which are mechanically connected to the shaft and arranged in spaced-apart relationship in a direction of the rotor axis to thereby define an intermediate space;
a stator having at least one stator disk which projects into the intermediate space to thereby define a bearing gap between confronting faces of the rotor disks and the stator disk on either side of the stator disk; and
a bearing device for non-contacting support of the rotor with respect to the stator, said bearing device comprising:
a magnetic bearing part for supporting the rotor in a radial direction with respect to the rotor axis, said magnetic bearing part including p3 annular tooth-like projections formed on the confronting faces of the rotor disks and the stator disk in an area of the bearing gaps, and
means, provided on one of the rotor and stator, for generating a magnetic field to produce a magnetic holding flux which is directed essentially in an axial direction between the stator disk and the rotor disks, and
an air bearing part for supporting the rotor in an axial direction with respect to the rotor axis, said air bearing part including
at least one bearing surface formed on the stator and defining a surface normal which is oriented essentially in an axial direction, and
at least one bearing body provided on the rotor in spaced-apart relationship to the bearing surface of the stator to thereby define an air bearing gap, said bearing body being supported with respect to the bearing surface by an air cushion in the air bearing gap.

31. The arrangement of claim 30, comprising n>2 of rotor disks arranged in spaced-apart relationship in a direction of the rotor axis with intermediate spaced being defined, and n−1 stator disks, which project into the intermediate spaces to thereby form corresponding bearing gaps between confronting faces of the rotor disks and the stator disks on either side of each stator disk.

32. The arrangement of claim 30, comprising two or more rotor disk pairs arranged in spaced-apart relationship in a direction of the rotor axis, each rotor disk pair including two rotor disks, wherein the rotor disks of the rotor disk pairs define pairs of intermediate spaces into which two or more stator disks project to define respective bearing gaps.

33. The arrangement of claim 30, wherein the bearing gap has in a preferred direction an axial extent which less than an axial extent in a direction opposite to the preferred direction, and wherein the air bearing part is connected at an end face thereof to an end part of the shaft, which end part lies in the preferred direction starting from the magnetic bearing part.

34. The arrangement of claim 30, wherein the bearing gap has in a preferred direction an axial extent which is less than an axial extent in a direction opposite to the preferred direction, and wherein the air bearing part is connected at an end face thereof to an end part of the shaft, which end part lies in the preferred direction starting from the magnetic bearing part.

35. The arrangement of claim 30, wherein the bearing gap has in a preferred direction an axial extent which is less than an axial extent in a direction opposite to the preferred direction, and wherein the bearing surface of the air bearing part is formed by subareas of the tooth-like projections of at least one stator disk whose surface normal points in the direction of the rotor axis, said subareas of the stator disk which lie in the direction of the preferred direction, starting from the rotor disk associated with the stator disk, defining the bearing surface.

36. The arrangement of claim 30, wherein the air bearing part is connected at an end face thereof to both end parts of the shaft.

37. The arrangement of claim 30, wherein the bearing surface of the air bearing part is formed by subareas of the tooth-like projections of at least two stator disks whose surface normals point in opposite axial directions.

38. The arrangement of claim 30, wherein the means of producing a magnetic field are part of the stator.

39. The arrangement of claim 36, wherein the means of producing a magnetic field are formed by permanent magnets or by a winding of an electromagnet.

40. The arrangement of claim 30, wherein the means for producing a magnetic field are part of the rotor.

41. The arrangement of claim 40, wherein the means for producing a magnetic field are formed by permanent magnets.

42. The arrangement of claim 30, further comprising a compressed-air supply connected to the stator for generating the air cushion in the air bearing gap, and a buffer volume connected to the compressed-air supply to maintain the air cushion for a limited time.

43. The arrangement of claim 30, wherein the air bearing part is constructed in the form of a foil air bearing.
